(19) United States
(12) Patent Application Publication
(10) Pub. No.: US 2018/0156441 A1
(43) Pub. Date: Jun. 7, 2018

(54) HEAT DISSIPATION DEVICE FOR LAMP

(71) Applicants: Tzu WANG, Taoyuan City (TW); Pieh-Jung WANG, Taoyuan City (TW)

(72) Inventor: Tzu WANG, Taoyuan City (TW)

(21) Appl. No.: 15/793,243

(22) Filed: Oct. 25, 2017

(30) Foreign Application Priority Data
Dec. 6, 2016 (TW) 105218634

(51) Int. Cl. F21V 29/71; F21V 29/51

(52) U.S. Cl. CPC F21V 29/717; F21V 29/51

(57) ABSTRACT

A heat dissipation device for a lamp includes a housing, a heat sink module and a light source module. The housing includes an opening. The heat sink module is received in the housing. The heat sink module includes a heat sink member which has a substrate. The substrate includes a first area and a second area surrounding a perimeter of the first area. One side of the first area includes an installation surface, and first hollow tubes extend from the other side of the first area. Second hollow tubes extend from two opposite sides of the second area. The light source module is thermally adhered to the installation surface and exposed from the opening. The heat of the light source module is expelled to the outside by means of the first hollow tubes and the second hollow tube to achieve excellent heat dissipation.

### TECHNICAL FIELD

The present disclosure relates to a lamp structure and, in particular, to a heat dissipation device for a lamp.

### BACKGROUND

Light-emitting diodes (LEDs) have high brightness, low power consumption, and a long lifespan, so the LEDs are extensively used. Also, because high power LED modules had been developed in the market, the LEDs are more widely adopted in all kinds of illumination devices, and using LED has become an environmentally friendly trend.

However, when LEDs are used in a high wattage lamp, the following problems occur. A high wattage LED light source generates a large amount of heat and causes high temperature. As the temperatures of the LEDs and electronic components inside the high wattage LED light source increase continuously, the LEDs and the electronic components malfunction or are short circuited. Therefore, it is desirable to provide a solution to effectively transfer the heat away from the high wattage lamp.

In views of this, in order to solve the above disadvantage, the inventor studied related technology and provided a reasonable and effective solution in the present disclosure.

### SUMMARY

It is an objective of the present disclosure to provide a heat dissipation device for a lamp, which expels the heat of a light source module to the outside by using a first hollow tube and a second hollow tube, thus achieving excellent heat dissipation by use of the heat dissipation device for the lamp.

Accordingly, the present disclosure provides a heat dissipation device for a lamp, comprising: a housing including an opening; a heat sink module accommodated in the housing, the heat sink module comprising a heat sink member which includes a substrate, the substrate including a first area and a second area surrounding a perimeter of the first area, one side of the first area including an installation surface, a plurality of first hollow tubes extending from the other side of the first area, a plurality of second hollow tubes extending from two opposite sides of the second area; and a light source module thermally adhered to the installation surface and exposed from the opening.

Accordingly, the present disclosure provides a heat dissipation device for a lamp, comprising a housing, a heat sink module, and a light source module. The housing includes an opening. The heat sink module is accommodated in the housing, and the heat sink module comprises two heat sink members and a plurality of heat pipes, wherein the two heat sink members are stacked one above the other, each heat sink member includes a substrate, each of the substrates includes a first area and a second area surrounding a perimeter of the first area, one side of the first area includes an installation surface, a plurality of first hollow tubes extend from the other side of the first area, a plurality of second hollow tubes extend from two opposite sides of the second area, the two installation surfaces are disposed at outer sides of the two heat sink members, the first hollow tubes are disposed at inner sides of the two heat sink members, and two ends of each heat pipe are interference fit into two corresponding ones of the first hollow tubes. The light source module is thermally adhered to one of the installation surfaces and is exposed from the opening.

### BRIEF DESCRIPTION OF THE DRAWINGS

The disclosure will become more fully understood from the detailed description, and the drawings given herein below is for illustration only, and thus does not limit the disclosure, wherein:

FIG. 1 is a perspective exploded view illustrating a heat dissipation device for a lamp according to the first embodiment of the present disclosure;

FIG. 2 is another perspective exploded view illustrating the heat dissipation device for the lamp according to the first embodiment of the present disclosure;

FIG. 3 is a perspective assembled view illustrating the heat dissipation device for the lamp according to the first embodiment of the present disclosure;

FIG. 4 is a perspective exploded view illustrating the heat dissipation device for the lamp according to the first embodiment of the present disclosure;

FIG. 5 is a cross-sectional view illustrating the heat dissipation device for the lamp according to the first embodiment of the present disclosure;

FIG. 6 is a perspective assembled view illustrating the heat dissipation device for the lamp according to the second embodiment of the present disclosure;

FIG. 7 is another perspective assembled view illustrating the heat dissipation device for the lamp according to the second embodiment of the present disclosure;

FIG. 8 is a cross-sectional view illustrating the heat dissipation device for the lamp according to the second embodiment of the present disclosure;

FIG. 9 is a perspective assembled view illustrating the heat dissipation device for the lamp according to the third embodiment of the present disclosure;

FIG. 10 is a perspective assembled view illustrating the heat dissipation device for the lamp according to the third embodiment of the present disclosure;

FIG. 11 is a cross-sectional view illustrating the heat dissipation device for the lamp according to the third embodiment of the present disclosure; and

FIG. 12 is a perspective view illustrating the heat dissipation device for the lamp according to the fourth embodiment of the present disclosure.

### DETAILED DESCRIPTION

Detailed descriptions and technical contents of the present disclosure are illustrated below in conjunction with the accompanying drawings. However, it is to be understood that the descriptions and the accompanying drawings disclosed herein are merely illustrative and exemplary and not intended to limit the scope of the present disclosure.

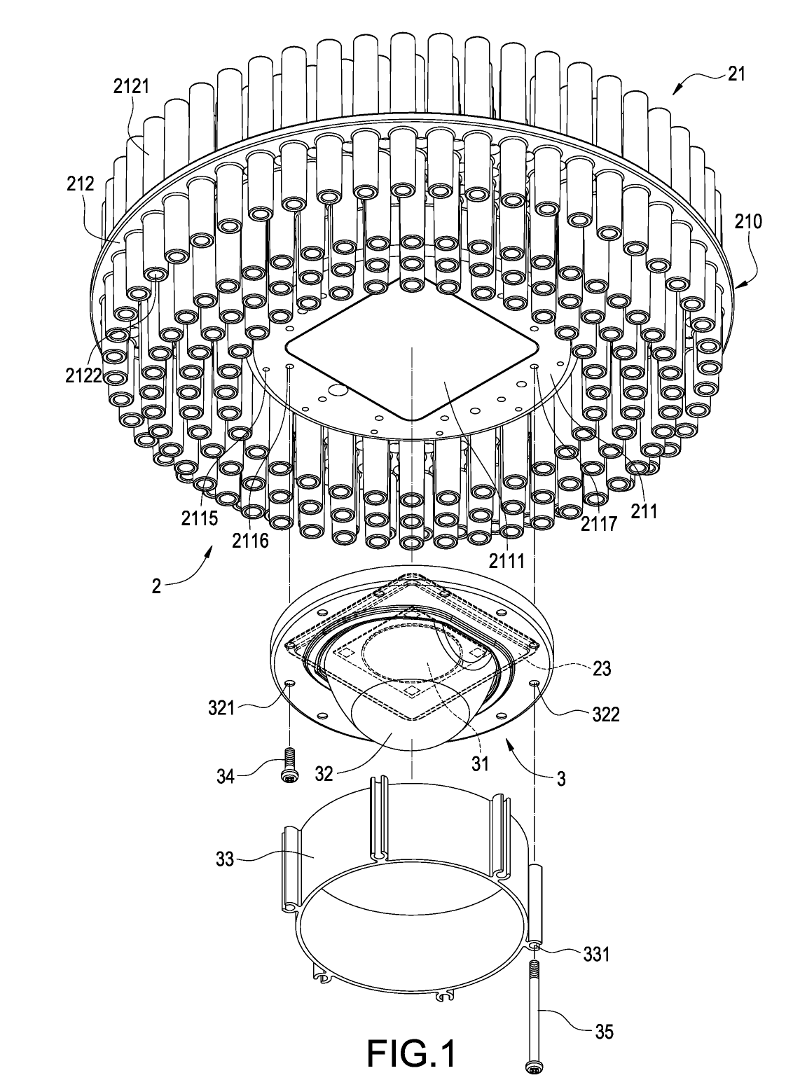

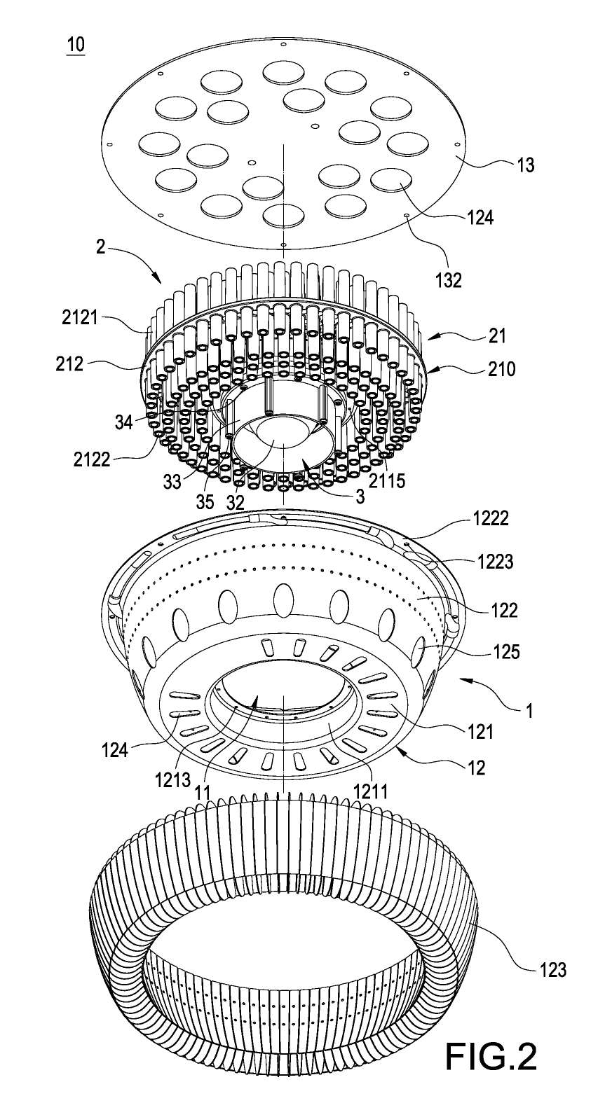

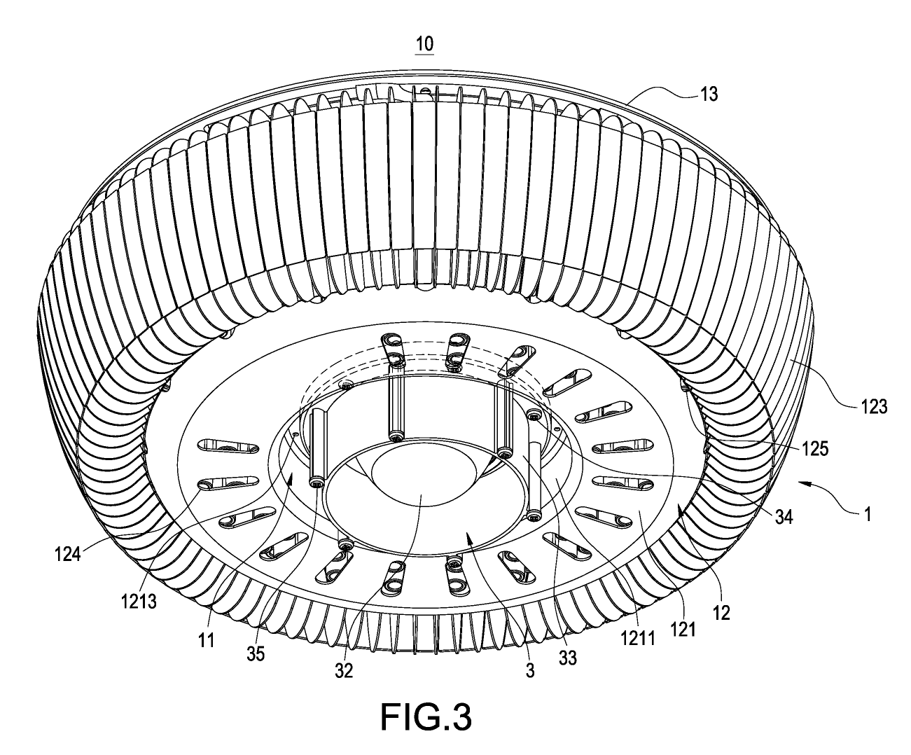

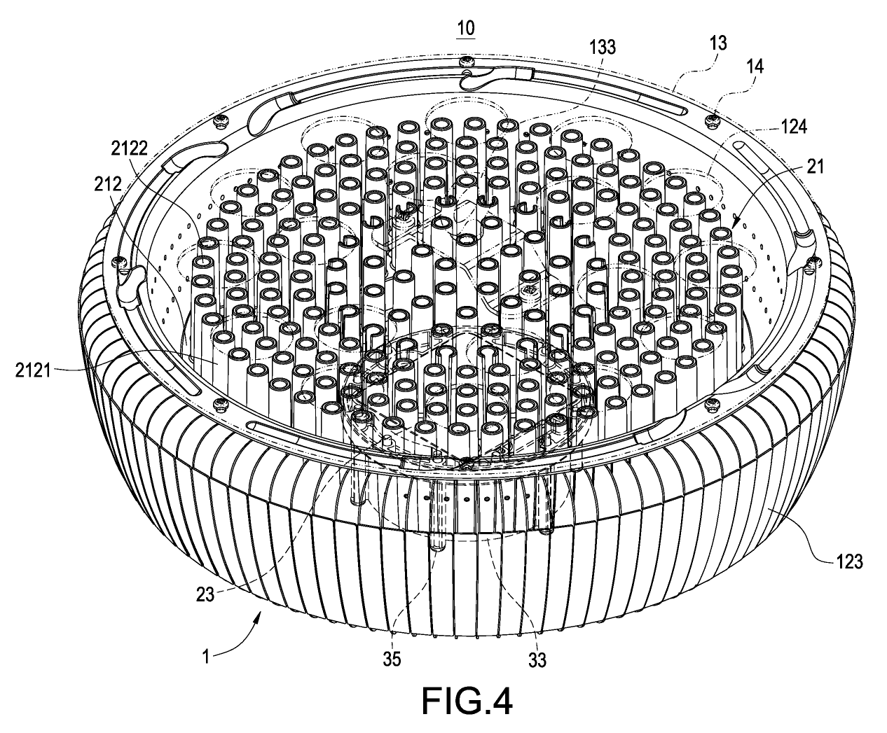

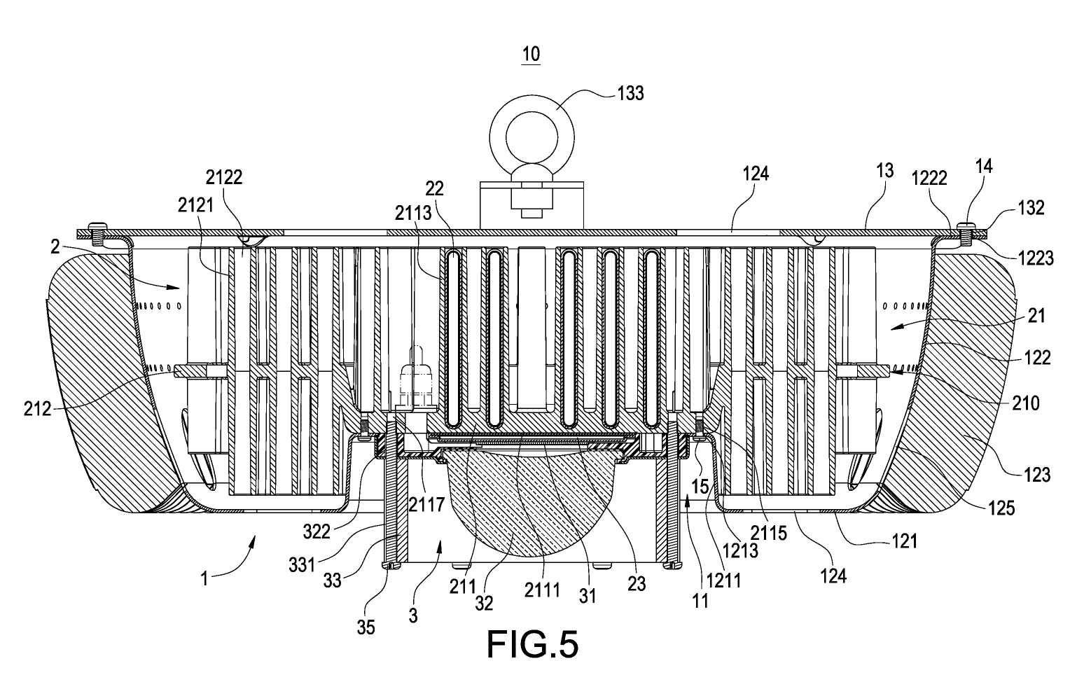

Please refer to FIGS. 1 to 5, illustrating a heat dissipation device for a lamp according to the first embodiment of the present disclosure. The heat dissipation device 10 includes a housing 1, a heat sink module 2 and a light source module 3.

Referring to FIGS. 1 to 5, the housing 1 includes an opening 11, the housing 1 includes a lower casing 12 and a cover plate 13 assembled to each other. The lower casing 12 includes a bottom plate 121 and an outer circular plate 122. A recess 1211 extends inwardly from a middle portion of the bottom plate 121, the opening 11 is formed at a bottom of the recess 1211, a plurality of heat sink fins 123 are connected to the exterior of the outer circular plate 122, a protruding ring plate 1222 extends from one end of the outer circular plate 122 away from the bottom plate 121, the protruding ring plate 1222 includes a plurality of first screw holes 1223, and the cover plate 13 includes a plurality of second screw holes 1223. A mounting rack 133 is connected to one side of the cover plate 13 away from the heat sink module 2.

Furthermore, the housing 1 includes a plurality of first screws 14 and a plurality of second screws 15, each first screw 14 is correspondingly fastened to each first screw hole 1223 and each second screw hole 132, so that the lower casing 12 and the cover plate 13 are assembled together.

Referring to FIGS. 1, 2, 4 and 5, the heat sink module 2 is accommodated between the lower casing 12 and the cover plate 13. In other words, the heat sink module 2 is accommodated inside the housing 1. The heat sink module 2 includes a heat sink member 21, a plurality of heat pipes 22 and a vapor chamber 23.

In detail, the heat sink member 21 includes a substrate 210, the substrate 210 includes a first area 211 and a second area 212 surrounding a perimeter of the first area 211, one side of the first area 211 includes an installation surface 2111, a plurality of first hollow tubes 2113 extend from the other side of the first area 211, the heat pipes 22 are interference fit into the first hollow tubes 2113 respectively, a plurality of second hollow tubes 2121 extend from two opposite sides of the second area 212, each of the second hollow tubes 2121 penetrates the substrate 210 to form an air passage 2122 inside each second hollow tube 2121.

The bottom plate 121 and the cover plate 13 include a plurality of first ports 124 disposed corresponding to the air passages 2122, and the outer circular plate 122 includes a plurality of second ports 125 disposed corresponding to the second hollow tubes 2121, thus improving heat dissipation of the second hollow tubes 2121.

Moreover, a plurality of first positioning holes 2115 are disposed on the installation surface 2111, a plurality of second positioning holes 1213 are disposed on the bottom of the recess 1211, and each second screw 15 is fastened to each first positioning hole 2115 and each second positioning hole 1213, so that the lower casing 12 and the heat sink member 21 are assembled together. A plurality of first through holes 2116 and a plurality of second through holes 2117 are disposed on the installation surface 2111.

Referring to FIGS. 1 to 5, the light source module 3 is thermally adhered to the installation surface 2111 and exposed from the opening 11. The light source module 3 includes a light-emitting-diode (LED) light source 31, a lens lampshade 32, a ring-shaped lampshade 33, a plurality of first fastening elements 34, and a plurality of second fastening elements 35, the lens lampshade 32 includes a plurality of first fixation holes 321 and a plurality of second fixation holes 322, and the ring-shaped lampshade 33 includes a plurality of third fixation holes 331. Each first fastening element 34 is fastened to each first through hole 2116 and each first fixation hole 321 to thereby fix the lens lampshade 32 to the installation surface 2111. Each second fastening element 35 is fastened to each second through hole 2117, each second fixation hole 322 and each third fixation hole 331 to thereby fix the ring-shaped lampshade 33 to the lens lampshade 32. The vapor chamber 23 is interposed between the installation surface 2111 and the lens lampshade 32, and the light-emitting-diode light source 31 is interposed between the vapor chamber 23 and the lens lampshade 32.

In the heat dissipation device 10 for the lamp, the housing 1 includes the opening 11, the heat sink module 2 is disposed inside the housing 1, the heat sink module 2 includes the heat sink member 21, the heat sink member 21 includes the substrate 210, the substrate 210 includes the first area 211 and the second area 212 surrounding the perimeter of the first area 211, one side of the first area 211 includes the installation surface 2111, the first hollow tubes 2113 extend from the other side of the first area 211, the second hollow tubes 2121 extend from two opposite sides of the second area 212, and the light source module 3 is thermally adhered to the installation surface 2111 and exposed from the opening 11.

To use the heat dissipation device 10 for the lamp, the light source module 3 is thermally adhered to the installation surface 2111. The heat of the light-emitting-diode light source 31 is uniformly expelled to the outside via the first hollow tubes 2113 and the second hollow tubes 2121. Each second hollow tube 2121 has the air passage 2122 inside, and the second hollow tube 2121 are uniformly distributed at two sides of the heat sink member 21 and in an outer peripheral area of the light source module 3, so the heat dissipation device 10 for the lamp achieves excellent heat dissipation.

Moreover, the heat sink module 2 further includes a plurality of heat pipes 22, and the heat pipes 22 are interference fit into the first hollow tubes 2113 respectively. Therefore, the heat of the light-emitting-diode light source 31 is even more quickly expelled to the outside via the heat pipes 22, thus further enhancing heat dissipation efficiency of the heat dissipation device 10 for the lamp.

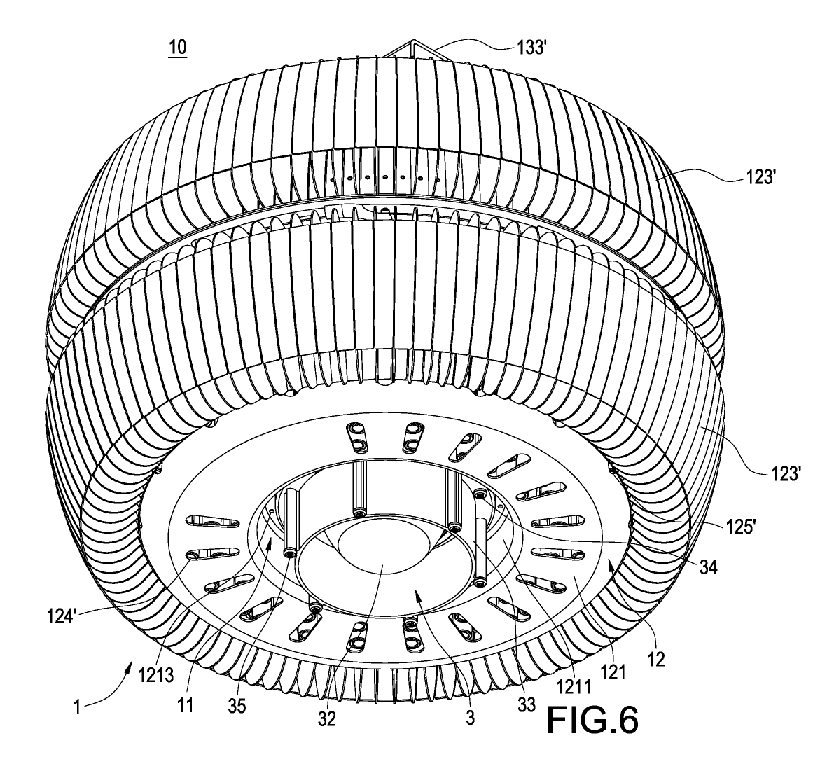

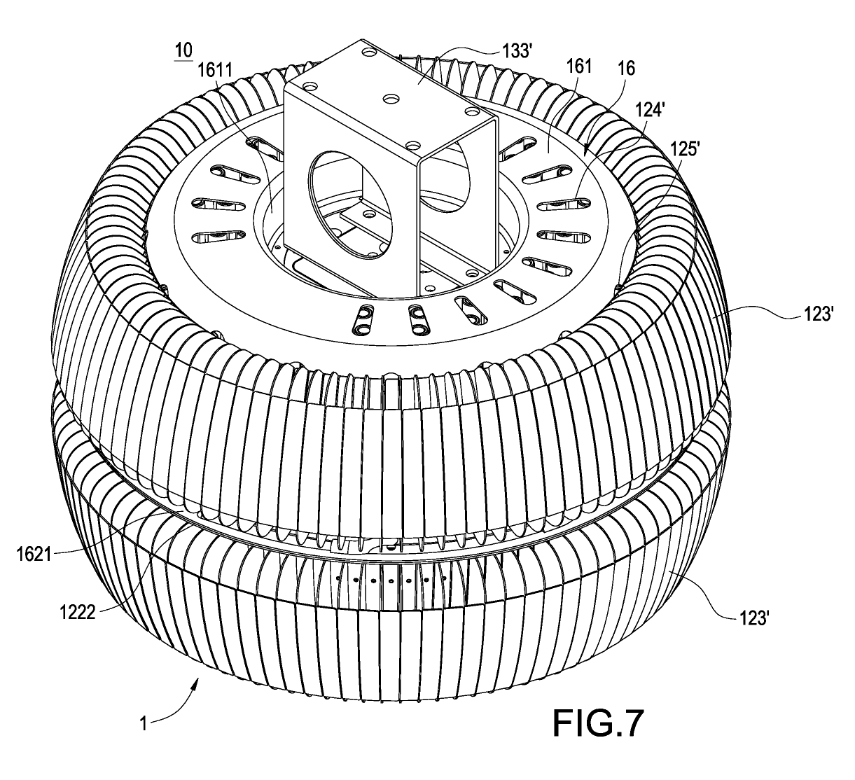

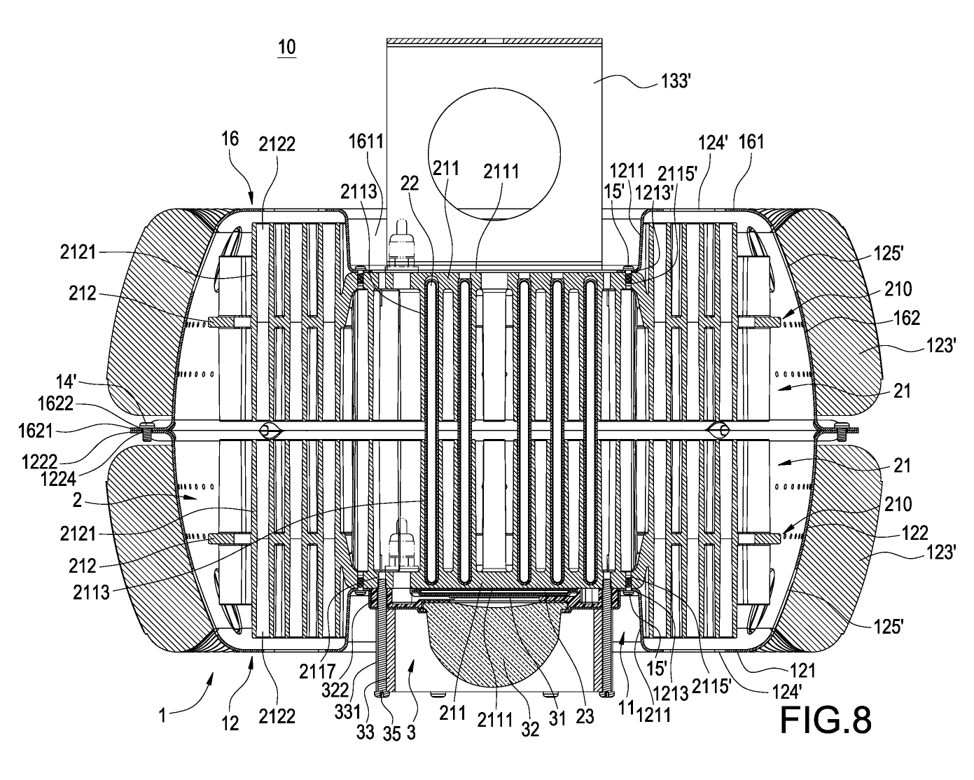

Please refer to FIGS. 6 to 8, illustrating the heat dissipation device 10 for the lamp according to the second embodiment of the present disclosure. The second embodiment is similar to the first embodiment. The second embodiment is different from the first embodiment in that, the second embodiment has two heat sink members 21.

In detail, two heat sink members are stacked on above the other inside the housing 1, each heat sink member 21 includes a substrate 210, each of the substrates 210 includes a first area 211 and a second area 212 surrounding a perimeter of the first area 211, one side of the first area 211 includes an installation surface 2111, a plurality of first hollow tubes 2113 extend from the other side of the first area 211, a plurality of second hollow tubes 2121 extend from two opposite sides of the second area 212, the two installation surfaces 2111 are disposed at outer sides of the two heat sink members 21, the first hollow tubes 2113 are disposed at inner sides of the two heat sink members 21. Two ends of each of the heat pipes 22 are interference fit into two corresponding ones of the first hollow tubes 2113. According, the present embodiment achieves similar effects and functions as the first embodiment.

The housing 1 includes a lower casing 12 and an upper casing 16. The heat sink module 2 is accommodated between the lower casing 12 and the upper casing 16, the upper casing 16 includes a top plate 161 and an outer peripheral plate 162, a cavity 1611 extends inwardly from a middle portion of the top plate 161, a mounting rack 133′ is connected to a bottom of the cavity 1611, a circular ring plate 1621 extends outwardly from one end of the outer peripheral plate 162 away from the top plate 161, the circular ring plate 1621 includes a plurality of second screw holes 1622, and a plurality of first positioning holes 2115′ are disposed on each installation surface 2111, and a plurality of second positioning holes 1213′ are disposed on the bottom of the recess 1211 and the bottom of the cavity 1611.

A plurality of heat sink fins 123′ are connected to the exterior of the outer circular plate 122 and the exterior of the outer peripheral plate 162. The bottom plate 121 of the lower casing 12 and the top plate 161 of the upper casing 16 include a plurality of first ports 124′ disposed corresponding to the air passages 2122, and the outer circular plate 122 of the lower casing 12 and the outer peripheral plate 162 of the upper casing 16 include a plurality of second ports 125′ disposed corresponding to the second hollow tubes 2121, thus improving heat dissipation of the second hollow tubes 2121.

Moreover, the housing 1 further includes a plurality of first screws 14′. Each first screw 14′ is correspondingly fastened to each first screw hole 1224 and each second screw hole 1622, so that the lower casing 12 and the upper casing 16 are assembled together.

Moreover, the housing 1 further includes a plurality of second screws 15′, and each second screw 15′ is fastened to each first positioning hole 2115′ and each second positioning hole 1213′, so that one of the heat sink members 21 and the lower casing 12 are assembled together, and the other heat sink member 21 and the upper casing 16 are assembled together.

Compared to the first embodiment, the second embodiment utilizes the heat pipe 22 to connect the two heat sink members 21, and the heat of the two heat sink members 21 are thermally conducted stably by means of the heat pipe 22. Thus, the number of the heat sink members 21 of the heat dissipation device 10 for the lamp can increase according to the amount of heat of the LED light source 31. Therefore, the heat dissipation device 10 for the lamp has the following advantage: the number of the heat sink members 21 and a heat dissipation area can be adjusted easily.

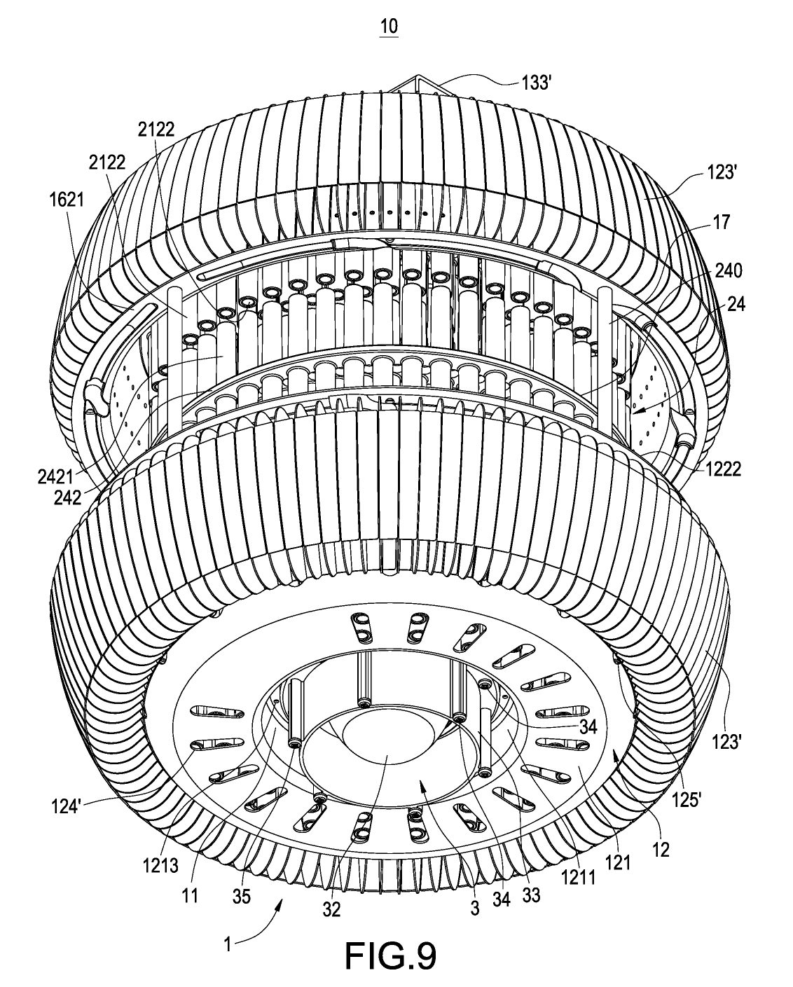

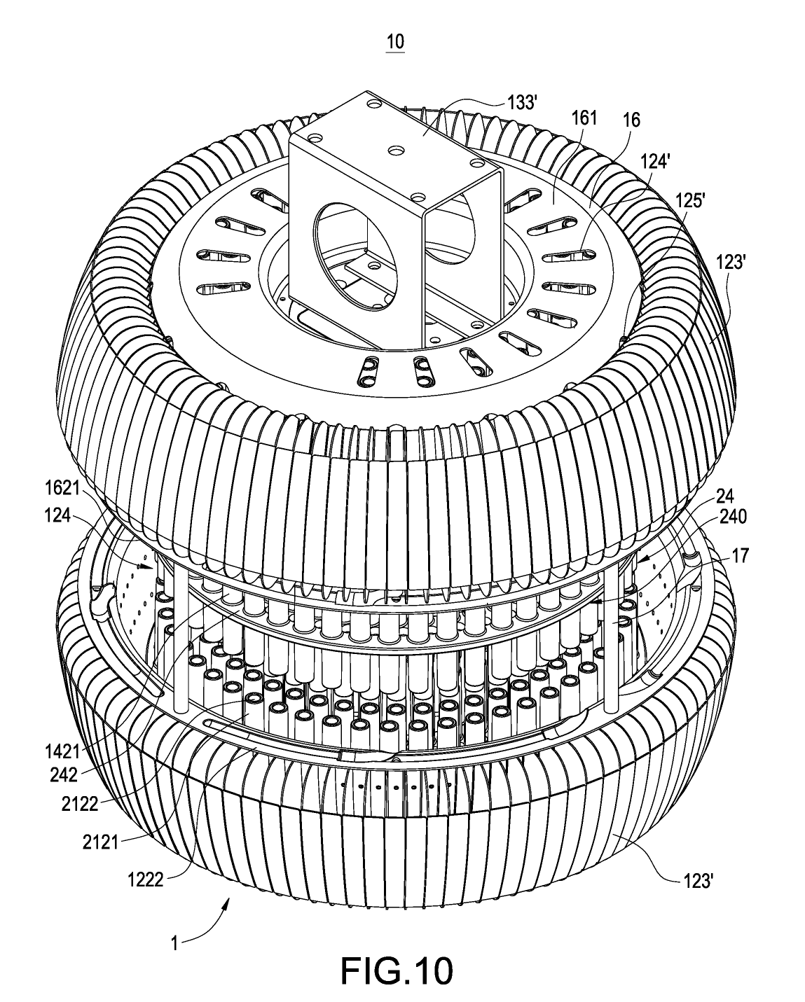

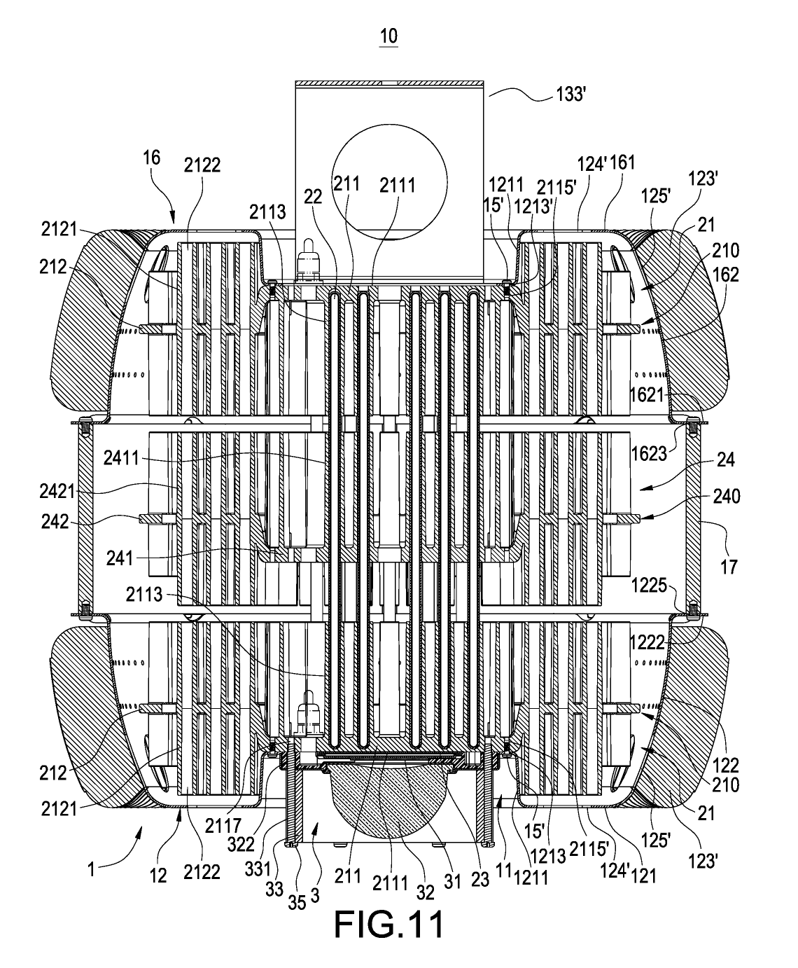

Please refer to FIGS. 9 to 12, illustrating the third and fourth embodiments of the heat dissipation device 10 for the lamp. The third and fourth embodiments are similar to the second embodiment, but are different in that the heat sink module 2 further includes one or more intermediate cooling members 24.

In detail, the intermediate cooling member 24 is disposed between the two heat sink members 21, the intermediate cooling member 24 includes a main board 240, the main board 240 includes a third area 241 and a fourth area 242 surrounding a perimeter of the third area 241, a plurality of coupling tubes 2411 penetrate two opposite sides of the third area 241, a plurality of third hollow tubes 2421 penetrate two opposite sides of the fourth area 242, and a middle section of each heat pipe 22 is interference fit into a corresponding one of the coupling tubes 2411.

The housing 1 includes a plurality of support pillars 17, the protruding ring plate 1222 of the lower casing 12 includes a plurality of first insertion holes 1225, the circular ring plate 1621 of the upper casing 16 includes a plurality of second insertion holes 1623, two ends of each support pillar 17 are respectively inserted into a corresponding one of the first insertion holes 1225 and a corresponding one of the second insertion holes 1623, and the support pillars 17 are disposed around the intermediate cooling member 24 to surround the same.

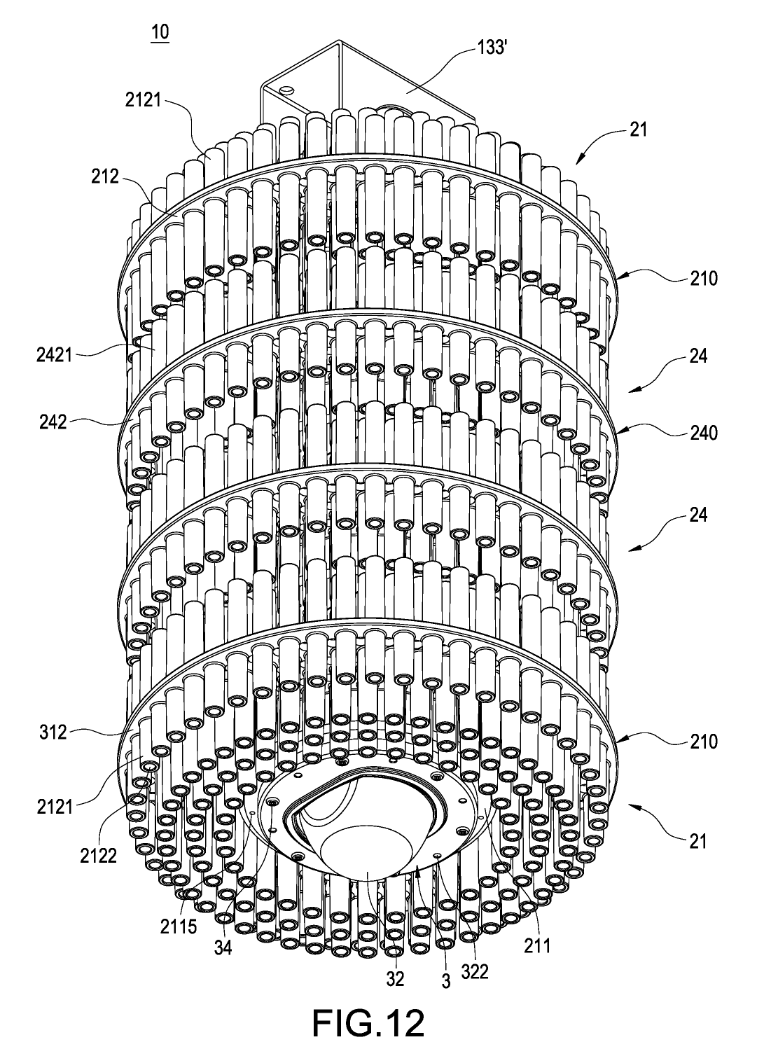

In FIGS. 9 to 11, the third embodiment includes only one intermediate cooling member 24. In FIG. 12, there are multiple intermediate cooling members 24. Accordingly, one or more intermediate cooling members 24 can be added between the two heat sink members 21, and the heat pipe 22 can be used to connect the two heat sink members 21 and the intermediate cooling member 24 for thermal conduction. Furthermore, according to the amount of heat of the LED light source 31, the number of the intermediate cooling members 24 can be adjusted, and more third hollow tubes 2421 can be added to increase an area for heat dissipation. As a result, the heat dissipation device 10 for the lamp has the following advantage: the number of the intermediate cooling members 24 and the area for heat dissipation can be adjusted easily, and the heat dissipation efficiency can be improved.

In summary, the heat dissipation device 10 for the lamp can achieve anticipated objectives and solve the conventional defects. The present disclosure also has industrial applicability, novelty and non-obviousness, so the present disclosure completely complies with the requirements of patentability. Therefore, a request to patent the present disclosure is filed pursuant to patent law. Examination is kindly requested, and allowance of the present application is solicited to protect the rights of the inventor.

What is claimed is:

1. A heat dissipation device for a lamp, comprising:
a housing including an opening;
a heat sink module accommodated in the housing, the heat sink module comprising:
a heat sink member including a substrate, the substrate including a first area and a second area surrounding a perimeter of the first area, one side of the first area including an installation surface, a plurality of first hollow tubes extending from the other side of the first area, a plurality of second hollow tubes extending from opposite sides of the second area; and
a light source module thermally adhered to the installation surface and exposed from the opening.

2. The heat dissipation device for the lamp according to claim 1, wherein the heat sink module further includes a plurality of heat pipes, and the heat pipes are interference fit into the first hollow tubes respectively.

3. The heat dissipation device for the lamp according to claim 1, wherein the housing includes a lower casing and a cover plate assembled to each other, the heat sink module is accommodated between the lower casing and the cover plate, the lower casing includes a bottom plate and an outer circular plate, a recess extending inwardly from a middle portion of the bottom plate, the opening is formed at a bottom of the recess, a plurality of heat sink fins are connected to the exterior of the outer circular plate, and a mounting rack is connected to one side of the cover plate away from the heat sink module.

4. The heat dissipation device for the lamp according to claim 3, wherein each of the second hollow tubes penetrates the substrate to form an air passage inside each second hollow tube, the bottom plate and the cover plate include a plurality of first ports disposed corresponding to the air passages, and the outer circular plate includes a plurality of second ports disposed corresponding to the second hollow tubes.

5. The heat dissipation device for the lamp according to claim 3, wherein the housing includes a plurality of first screws, a protruding ring plate extends from one end of the outer circular plate away from the bottom plate, the protruding ring plate includes a plurality of first screw holes, the cover plate includes a plurality of second screw holes, and each first screw is correspondingly fastened to each first screw hole and each second screw hole.

6. The heat dissipation device for the lamp according to claim 3, wherein the housing further includes a plurality of second screws, a plurality of first positioning holes are disposed on the installation surface, a plurality of second positioning holes are disposed on the bottom of the recess, and each second screw is fastened to each first positioning hole and each second positioning hole.

7. The heat dissipation device for the lamp according to claim 1, wherein a plurality of first through holes and a plurality of second through holes are disposed on the installation surface, the heat sink module further includes a vapor chamber, the light source module includes a light-emitting-diode light source, a lens lampshade, a ring-shaped lampshade, a plurality of first fastening elements and a plurality of second fastening elements, the lens lampshade includes a plurality of first fixation holes and a plurality of second fixation holes, the ring-shaped lampshade includes a plurality of third fixation holes, each first fastening element is fastened to each first through hole and each first fixation hole, each second fastening element is fastened to each second through hole, each second fixation hole and each third fixation hole, the vapor chamber is interposed between the installation surface and the lens lampshade, and the light-emitting-diode light source is interposed between the vapor chamber and the lens lampshade.

8. The heat dissipation device for the lamp, comprising:
a housing including an opening;
a heat sink module accommodated in the housing, the heat sink module comprising:
two heat sink members stacked one above the other, each heat sink member including a substrate, each of the substrates including a first area and a second area surrounding a perimeter of the first area, one side of the first area including an installation surface, a plurality of first hollow tubes extending from the other side of the first area, a plurality of second hollow tubes extending from opposite sides of the second area, the two installation surfaces being disposed at outer sides of the two heat sink members, the first hollow tubes being disposed at inner sides of the two heat sink members; and
a plurality of heat pipes, two ends of each heat pipe being interference fit into two corresponding ones of the first hollow tubes; and
a light source module thermally adhered to one of the installation surfaces and exposed from the opening.

9. The heat dissipation device for the lamp according to claim 8, wherein the housing includes a lower casing and an upper casing, the heat sink module is accommodated between the lower casing and the upper casing, the lower casing includes a bottom plate and an outer circular plate, a recess extending inwardly from a middle portion of the bottom plate, the opening is formed at a bottom of the recess, the upper casing includes a top plate and an outer peripheral plate, a cavity extending inwardly from a middle portion of the top plate, a mounting rack is connected to a bottom of the cavity, and a plurality of heat sink fins are connected to the exterior of the outer circular plate and the exterior of the outer peripheral plate.

10. The heat dissipation device for the lamp according to claim 9, wherein the heat sink module further includes at least one intermediate cooling member, the intermediate cooling member is disposed between the two heat sink members, the intermediate cooling member includes a main board, the main board includes a third area and a fourth area surrounding a perimeter of the third area, a plurality of coupling tubes penetrate two opposite sides of the third area, a plurality of third hollow tubes penetrate two opposite sides of the fourth area, and a middle section of each of the heat pipes is interference fit into a corresponding one of the coupling tubes.

11. The heat dissipation device for the lamp according to claim 10, wherein the housing includes a plurality of support pillars, a protruding ring plate extends outwardly from one end of the outer circular plate away from the bottom plate, the protruding ring plate includes a plurality of first insertion holes, a circular ring plate extends outwardly from one end of the outer peripheral plate away from the top plate, the circular ring plate includes a plurality of second insertion holes, two ends of each support pillar are respectively inserted into a corresponding one of the first insertion holes and a corresponding one of the second insertion holes, and the support pillars are disposed around the intermediate cooling member to surround the same.

12. The heat dissipation device for the lamp according to claim 9, wherein each of the second hollow tubes penetrates the substrate to form an air passage inside each second hollow tube, the bottom plate and the top plate include a plurality of first ports disposed corresponding to the air passages, and the outer circular plate and the outer peripheral plate include a plurality of second ports disposed corresponding to the second hollow tubes.

13. The heat dissipation device for the lamp according to claim 9, wherein the housing further includes a plurality of first screws, a protruding ring plate extends from one end of the outer circular plate away from the bottom plate, the protruding ring plate includes a plurality of first screw holes, a circular ring plate extends outwardly from one end of the outer peripheral plate away from the top plate, the circular ring plate includes a plurality of second screw holes, and each first screw is correspondingly fastened to each first screw hole and each second screw hole.

14. The heat dissipation device for the lamp according to claim 9, wherein the housing further includes a plurality of second screws, a plurality of first positioning holes are disposed on the installation surface, a plurality of second positioning holes are disposed on the bottom of the recess and the bottom of the cavity, and each second screw is fastened to each first positioning hole and each second positioning hole.

15. The heat dissipation device for the lamp according to claim 8, wherein a plurality of first through holes and a plurality of second through holes are disposed on the installation surface adjacent to the opening, the heat sink module further includes a vapor chamber, the light source module includes a light-emitting-diode light source, a lens lampshade, a ring-shaped lampshade, a plurality of first fastening elements and a plurality of second fastening elements, the lens lampshade includes a plurality of first fixation holes and a plurality of second fixation holes, the ring-shaped lampshade includes a plurality of third fixation holes, each first fastening element is fastened to each first through hole and each first fixation hole, each second fastening element is fastened to each second through hole, each second fixation hole and each third fixation hole, the vapor chamber is interposed between the installation surface and the lens lampshade, and the light-emitting-diode light source is interposed between the vapor chamber and the lens lampshade.
